(19) United States
(12) Patent Application Publication
(10) Pub. No.: US 2017/0039488 A1
(43) Pub. Date: Feb. 9, 2017

(54) SYSTEM AND METHOD FOR A TAXI SHARING BRIDGE SYSTEM

(71) Applicant: Hitachi, Ltd., Tokyo (JP)

(72) Inventor: Wujuan LIN, Singapore (SG)

(21) Appl. No.: 14/819,921

(22) Filed: Aug. 6, 2015

(51) Int. Cl. G06Q 10/02; G08G 1/00; G01C 21/34; G06Q 50/30

(52) U.S. Cl. CPC G06Q 10/02; G06Q 50/30; G08G 1/202; G01C 21/3438

(57) ABSTRACT

The system and method disclosed herein provides a taxi sharing bridge system, which uses taxis from a plurality of taxi companies (and their respective taxi sharing systems) to effectively dispatch commuters to their specific destinations when a disruption occurs in a public transportation system. The system and method includes client devices associated with a plurality of users, a taxi sharing bridge system and a plurality of taxi sharing systems. The system uses past transportation service usage data to determine a preferred route of a user to travel from an origin to a destination. The system takes into account a priority level of the users who choose to use the service to group them into taxis to arrive at a destination upon a disruption in the public transportation system. The priority level may be based on the commuter's waiting time, the commuter's loyalty, and preferred route type.

### BACKGROUND

Public transportation services, such as railway systems (passenger trains), buses, electric tram car, etc., play a critical role in a city to transport large numbers of commuters. People rely on public transportation services to move around in cities and public transportation services are typically a major component in a city.

Public transportation services suffer from disruptions in their service, which affect the commuters, depending on their route of travel in the service. During a service disruption, many commuters are and will be affected and those commuters need to find alternative transport service to reach their destinations. Usually, when there is a service disruption for a train system, for example, a commuter may contact a taxi company using an application on the commuter's electronic device (e.g., mobile device) or by phone calling the taxi company. If the contacted taxi company does not have any taxis available at the time, the commuter needs to contact another taxi company to arrange a pick-up. The drawbacks associated with contacting a taxi company when a disruption occurs is that there is usually a long waiting time for finding an available taxi and waiting for the actual pick-up, and the taxi fare is much higher than that of a public transportation service. Therefore, using a taxi to travel when the public transportation experiences the disruption is very inconvenient to the commuters.

To reduce the taxi fare, there are taxi sharing systems proposed in e.g., “Taxi Calling and Sharing System based on Mobile Terminal”, Chinese Pat. No. CN202362930 and “Dynamic Taxi-Sharing System and Sharing Method Thereof”, U.S. Pat. No. 8,799,038. In these systems, each taxi company has its own taxi sharing system, which matches people who are going to a similar destination. However, the only people matched for the sharing service are those who contacted the same company (to use their sharing service). Those systems do not take into account arranging a taxi for people who are going to the same destination but used taxi sharing systems of other companies.

Accordingly, some drawbacks to these systems are that the matching system employed by each of the taxi companies only match people who request (e.g., through an application or a call) a service for that particular taxi company. As a result, the success rate of matching people who are going to a similar destination is relatively low. The systems also do not give priority to a commuter who did not previously get a match using another taxi company and is now re-trying with another company. These systems have a long waiting time for the people using it.

An objective of the present invention is to provide a system that, after a service disruption of a public transportation system, groups commuters heading to a same or similar destination into a taxi, while utilizing the taxi sharing services of many taxi companies, taking into account the priority of each commuter, to minimize the total travel time for commuters with higher priority.

There are existing technologies for services that are able to use taxis from multiple taxi companies, but these technologies do not address the aforementioned problems. Chinese Pat. No. CN202871082 describes a taxi sharing service agent, which provides only a common interface for commuters to request taxi sharing from a single taxi company. If the request failed at one taxi company, commuters can use the same interface to request taxi sharing from another taxi company. On the other hand, Japanese Pub. No. JP2004-164256 describes a Bus Service Center, which can receive a taxi calling request from a bus, and forward the request to a taxi company. If the request fails, the system (i.e., Bus Service Center) will resend the request to another taxi company. These existing technologies do not consider a priority of a commuter and the waiting time a commuter may be experiencing, and cannot choose optimum schedules from a plurality of taxi companies for commuters.

### BRIEF SUMMARY OF THE INVENTION

The system and method disclosed herein provides a taxi sharing bridge system, which uses taxis from a plurality of taxi companies (and their respective taxi sharing systems) to effectively dispatch commuters to their specific destinations. In one example, the taxi sharing bridge system pro-actively consolidates taxi sharing demand from commuters affected by a disruption into groups, and is able to dynamically update a commuter's priority based on their waiting time, travel behavior, and a priority policy. The system then generates a group request based on the priority and sends the request to all taxi companies, and selects the optimum schedules for each group to minimize the total travel time for commuters with high priority.

By using the taxi sharing bridge system, a commuter inconvenienced by a disruption in public transportation will automatically be queried by the system to determine if he or she need a taxi and then automatically have a taxi arranged to pick him or her and others up at a necessary pick-up point (e.g., train stations or nearby taxi stands) to be transported to their destination. The taxi sharing bridge system utilizes existing taxi sharing systems operated by a plurality of taxi companies to automatically select a taxi for the commuter based on parameters, such as priority of the commuter, waiting time, and loyalty.

### BRIEF DESCRIPTION OF THE DRAWINGS

FIG. 1 illustrates an overview of the client devices, public transportation system, taxi sharing bridge system, and taxi sharing systems connected over networks according to some implementations.

FIG. 2 illustrates a block diagram of one or more client devices according to some implementations.

FIG. 3 illustrates a block diagram of one or more taxi sharing bridge systems according to some implementations.

FIG. 4 illustrates a block diagram of one or more taxi sharing systems according to some implementations.

FIG. 5 is a flow diagram illustrating an example process for registering a user of the taxi sharing bridge system according to some implementations.

FIG. 6 illustrates an example of a user information table according to some implementations.

FIG. 7 is a flow diagram illustrating an example process for determining a user's loyalty status according to some implementations.

FIG. 8 is a flow diagram illustrating an example process for determining a commuter's travel demand according to some implementations.

FIG. 9 illustrates an example of a transit log table according to some implementations.

FIG. 10 illustrates an example of a master data table according to some implementations.

FIG. 11 illustrates an example of a travel demand table according to some implementations.

FIG. 12 illustrates an example of a disruption information table according to some implementations.

FIG. 13 is a flow diagram illustrating an example process for consolidating the travel demand according to some implementations.

FIG. 14 is a flow diagram illustrating an example process for generating a taxi sharing request according to some implementations.

FIG. 15 illustrates an example of a taxi sharing request table according to some implementations.

FIG. 16 is a flow diagram illustrating an example process for updating a priority of a commuter according to some implementations.

FIG. 17 is a flow diagram illustrating an example process for updating a commuter's priority according to some implementations.

FIG. 18 is a flow diagram illustrating an example process for generating a taxi sharing group request according to some implementations.

FIG. 19 illustrates an example of sharing groups according to some implementations.

FIG. 20 illustrates an example of a taxi sharing group request according to some implementations.

FIG. 21 is a flow diagram illustrating an example process executed by one or more taxi sharing systems according to some implementations.

FIG. 22 illustrates an example of a schedule from a taxi sharing system according to according to some implementations.

FIG. 23 is a flow diagram illustrating an example process for consolidating schedules from one or more taxi sharing systems according to some implementations.

FIG. 24 illustrates an example of a merged schedule according to according to some implementations.

FIG. 25 is a flow diagram illustrating an example process for determining taxi assignments for commuters and informing the commuters of such information according to some implementations.

FIG. 26 is a flow diagram illustrating an example process for assigning commuters to taxis according to some implementations.

### DETAILED DESCRIPTION

In the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the following detailed description are presented in terms of algorithms or processes and symbolic representations of operations within a computer. These algorithmic descriptions and symbolic representations are the means used by those skilled in the data processing arts to most effectively convey the essence of their innovations to others skilled in the art. An algorithm or process is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” “mining,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Some implementations relate to an apparatus (one or more apparatuses) for performing the operations herein. The apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. The operations described in flowcharts, for example, may be executed by one or more processing devices, e.g., central processing units (CPUs), processors, or controllers.

Some of the figures are flow diagrams illustrating example processes according to some implementations. The processes are illustrated as collections of blocks in logical flow diagrams, which represent a sequence of operations, some or all of which can be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation. Any number of the described blocks can be combined in any order and/or in parallel to implement the process, or alternative processes, and not all of the blocks need be executed. For discussion purposes, the processes are described with reference to the environments, systems and devices described in the examples herein, although the processes may be implemented in a wide variety of other environments, systems and devices.

Although the data may be described as being stored in tables, the data may be stored in other appropriate data structures.

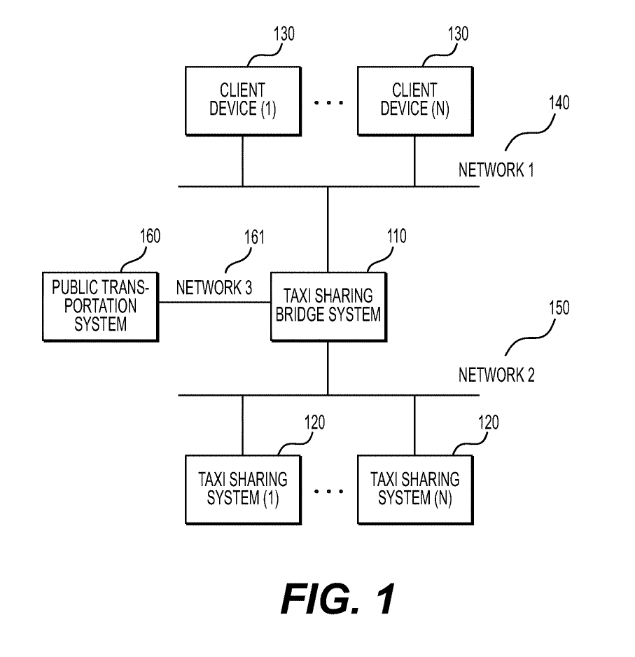

The present invention is illustrated and described with the following drawings. FIG. 1 illustrates an overview of the client devices 130, public transportation system 160, taxi sharing bridge system(s) 110, and taxi sharing systems 120 connected over networks. Each commuter may be associated with a client device 130.

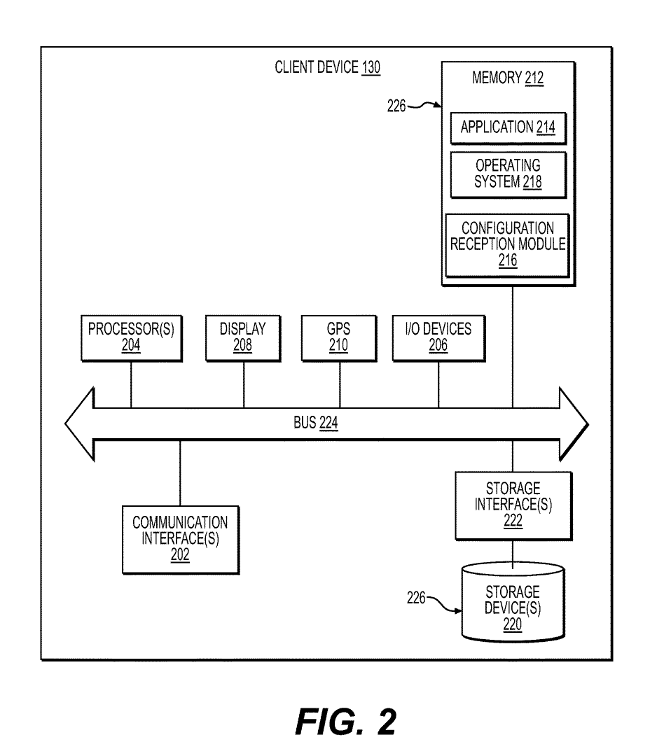

Each client device 130 may be a smart phone, tablet, or the like, and may include a respective instance of an application 214 that executes on the respective client device 130 for interacting with the taxi sharing bridge system 110. In some examples, the client application 214 and the taxi sharing bridge system 110 may communicate with each other via one or more application programming interfaces (APIs). For instance, the application 214 on the client device 130 may present information in one or more graphic user interfaces (GUIs). The client device 130 may be a computing device that is configured to receive information via email, instant messaging, such as SMS, or other electronic communication. The client device 130 may also be a mobile device, configured to receive information from the taxi sharing bridge system 110 via an SMS text message, voicemail, telephone call, or the like. The components of the client device 130 are further explained with reference to FIG. 2.

A commuter uses a client device 130 to connect to a taxi sharing bridge system 110 through one or more networks 140. One or more networks 140, 150, 161 may include any appropriate network, including a wide area network (WAN), internet, local area network (LAN), wireless networks, such as a cellular network, a local wireless network (e.g., Wi-Fi and/or close-range wireless communications). The one or more networks 140, 150, 161 may also include a wired network (consisting of fiber optics and Ethernet), or any combination thereof. Accordingly, the one or more networks 140, 150, 161 may include wired and/or wireless communication technologies, or any combination thereof. Protocols implemented by the client devices 130, taxi sharing bridge system 110, public transportation system 160, and taxi sharing systems 120 for communicating over networks 140, 150, and 161 are well known and will not be discussed herein in detail.

The taxi sharing bridge system 110, provides taxi sharing bridging service to commuters, by using taxis from a plurality of taxi sharing systems 120. The communication between the taxi sharing bridge system 110 and taxi sharing systems 120 is through one or more networks 150. In addition, the public transportation system 160 communicates with the taxi sharing bridge system 110 over one or more networks 161 to provide information (such as transit logs and disruption information) to the taxi sharing bridge system 110.

FIG. 2 illustrates a block diagram of one or more client devices 130 according to some implementations. The client device 130 may be any types of mobile device. Some examples of the client device 130 may include smart phones and mobile communication devices; tablet computing devices; laptops, netbooks and other portable computers; wearable computing devices and/or body-mounted computing devices, which may include watches and any other portable device capable of sending communications and performing the functions according to the techniques described herein. Further, in some examples, the client device 130 may be a stationary or semi-stationary computing device, such as a desktop computer or other device with computing capabilities.

In the exemplary illustration of FIG. 2, the client device 130 includes components such as at least one processor 204, a memory 224, one or more communication interfaces 202, one or more input/output (I/O) devices 206, a display 208, a storage interface 222, one or more storage devices 220, and a system bus 224. Each processor(s) 204 may itself comprises one or more processors or processing cores. For example, the processor(s) 204 can be implemented as one or more microprocessors, microcomputers, microcontrollers, digital signal processors, central processing units, state machines, and/or logic circuitries. In some cases, the processor(s) 204 may be one or more hardware processors and/or logic circuits of a suitable type that is specifically programmed or configured to execute the algorithms and processes described herein. The processor(s) 204 can be configured to fetch and execute computer-readable processor-executable instructions stored in the computer-readable media 226. Data communicated among the processor(s) 204 and the other components may be transferred via the system bus 224 or other suitable connection.

The memory 212 and storage device(s) 220 are examples of computer-readable media 226. Such computer-readable media 226 may include volatile and non-volatile memory and/or removable and non-removable media implemented in any type of technology for storage of information such as computer-readable processor-executable instructions, data structures, program modules or other data. The computer-readable media 226 may include, but is not limited to, RAM, ROM, flash memory, solid-state storage, magnetic disk storage, optical storage, and/or other computer-readable media technology. Further, in some cases, the client device 130 may access external storage, such as RAID storage systems, storage arrays, network attached storage, storage area networks, cloud storage, or any other medium that can be used to store information and that can be accessed by the processor(s) 204 directly or through another computing device or network. Accordingly, the computer-readable media 226 may be computer storage media able to store instructions, modules, or components, which are executed by the processor(s) 204.

The computer-readable media 226 may be used to store any number of functional components that are executable by the processor(s) 204. In some implementations, these functional components comprise instructions or programs that are executable by the processor(s) 204 and that, when executed, implement operational logic for performing the actions and services attributed to the client device 130. Functional components of the client device 130 that may be stored in the memory 212 may include the application 214, which as discussed above communicates with the taxi sharing bridge system 110 and may present the user with one or more GUIs via a display 208 of the client device 130. Additional functional components may include an operating system 218 for controlling and managing various functions of the client device 130 and for enabling basic user interactions with the client device 130. The storage interface 222 may provide raw data storage and read/write access to the storage device(s) 220. The modules, application 214, and operating system 218 may access data in the storage device(s) 220 via the storage interface 222.

In addition, the computer-readable media 226 may also store data used by the functional components. Depending on the type of the client device 130, the computer-readable media 226 may also include other functional components and data, such as other modules, which may include applications, programs, drivers, etc., and the data used or generated by the functional components. Also stored on the computer-readable media 226 are a confirmation reception module 216, which includes instructions, independently or in combination with the application 214, for providing a GUI for displaying information and for allowing the user to confirm or deny the use of the service when prompted by the taxi sharing bridge system 110. For example, the configuration reception module 216 may handles reception of information from the taxi sharing bridge system 110 and sending of information to the taxi sharing bridge system 110.

The communication interface(s) 202 may include one or more interfaces and hardware components for enabling communication with various other devices, such as over the network(s) 140 or directly. For example, communication interface(s) 202 may enable communication through one or more of the Internet, cable networks, cellular networks, wireless networks (e.g., Wi-Fi) and wired networks (e.g., fiber optic and Ethernet), as well as close-range communications, and the like, as additionally enumerated elsewhere herein.

FIG. 2 further illustrates that the client device 130 may include a display 208. Depending on the type of computing device used as the client device 130, the display 208 may employ any suitable display technology. For example, the display 208 may be a liquid crystal display, a plasma display, a light emitting diode display, an OLED (organic light-emitting diode) display. In some examples, the display 208 may have touch sensor technology associated therewith. The touch screen technology may enable interaction between the user and the GUI(s) presented to the user on the display 208. Accordingly, implementations herein are not limited to any particular display technology.

The client device 130 may also include the one or more I/O devices 206. The I/O devices 206 may include speakers, a microphone, a camera, and various user controls (e.g., buttons, a joystick, a keyboard, a keypad, etc.), a haptic output device, and so forth. Other components included in the client device 130 may include various types of sensors, which may include a global positioning satellite (GPS) receiver 210 able to indicate location information, as well as other sensors (not shown) such as an accelerometer, gyroscope, compass, proximity sensor, and the like. In some cases, the GPS receiver 210 may be used by the application 214 to determine a current geographic location of the client device 130 or a nearby public transportation station (e.g., train station or bus station). Additionally, or alternatively, the communication interface(s) 202 may be used to determine the current location of the client device 130, such as based on communication with nearby cell towers, wireless access points, and the like. Additionally, the client device 130 may include various other components (not shown) including removable storage, and a power source, such as a battery and power control unit, and so forth.

Although the application module 214 is shown in block form separate from the configuration reception module 216, the application module 214 may include the functionality of the configuration reception module 216. The illustrations of the modules provided herein are exemplary. The modules may be executed by the processor(s) 204 of the client device 130.

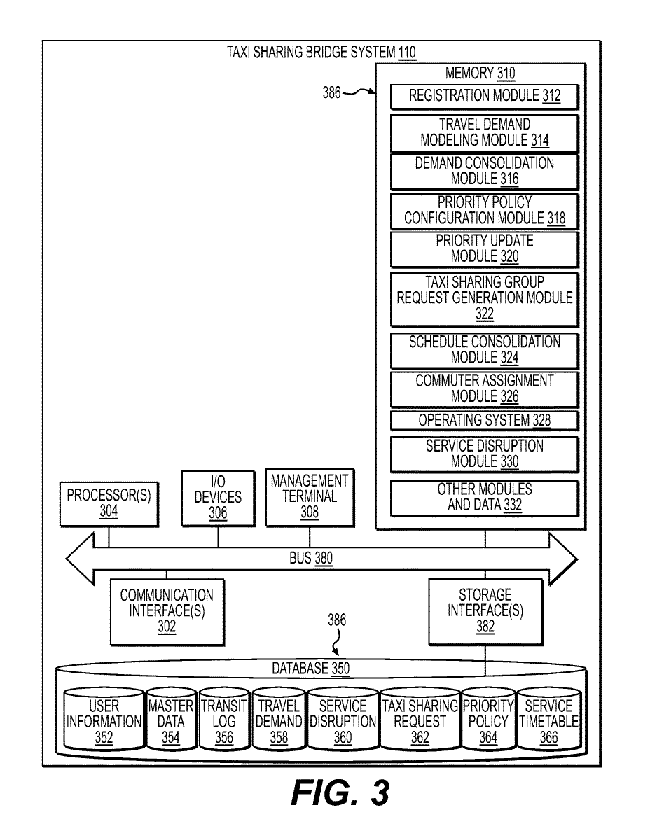

FIG. 3 illustrates a block diagram of a taxi sharing bridge system 110 according to some implementations. The taxi sharing bridge system 110 may include one or more servers or other types of computing devices that may be embodied in any number of ways. For instance, in the case of a server, the modules, other functional components of the taxi sharing bridge system 110, and data may be implemented on a single server, a cluster of servers, a server farm or data center, a cloud-hosted computing service, and so forth, although other computer architectures may additionally or alternatively be used. These components and data may alternatively be distributed across different computing devices and different locations in any manner. Consequently, the functions may be implemented by one or more service computing devices, with the various functionality described above distributed in various ways across the different computing devices. Multiple taxi sharing bridge systems 110 may be located together or separately, and organized, for example, as virtual servers, server banks, and/or server farms. The described functionality may be provided by the servers of a single entity or enterprise, or may be provided by the servers and/or services of multiple different entities or enterprises.

In the illustrated example of the taxi sharing bridge system 110 of FIG. 3, each taxis sharing bridge system 110 may include one or more processors 304, a memory 310, one or more communication interfaces 302, I/O device(s) 306, a management terminal 308, a storage interface 382, a database 350 and a system bus 380. Each processor 304 may be a single processing unit or a number of processing units, and may include single or multiple computing units or multiple processing cores. The processor(s) 304 can be implemented as one or more microprocessors, microcomputers, microcontrollers, digital signal processors, central processing units, state machines, and/or logic circuitries. For instance, the processor(s) 304 may be one or more hardware processors and/or logic circuits of any suitable type specifically programmed or configured to execute the algorithms and processes described herein. The processor(s) 304 can be configured to fetch and execute computer-readable instructions stored in the computer-readable media 386, which can program the processor(s) 304 to perform the functions described herein. Data communicated among the processors (304) and the other components may be transferred via the system bus 380 or other suitable connections.

The memory 310 may be an example of computer-readable media 386 and may include volatile and nonvolatile memory and/or removable and non-removable media implemented in any type of technology for storage of information, such as computer-readable instructions, data structures, program modules, or other data. Such computer-readable media 386 may include, but is not limited to, RAM, ROM, flash memory, optical storage, solid state storage, magnetic disk storage, RAID storage systems, storage arrays, network attached storage, storage area networks, cloud storage, or any other medium that can be used to store the desired information and that can be accessed by a computing device.

The computer-readable media 386 may be used to store any number of functional components that are executable by the processors 304. In many implementations, these functional components comprise instructions or programs that are executable by the processors 304 and that, when executed, specifically configure the one or more processors 304 to perform the actions attributed to the taxi sharing bridge system 110. Functional components stored in the memory 310 may include, a registration module 312, a travel demand modeling module 314, a demand consolidation module 316, a priority policy configuration module 318, a priority update module 320, a taxi sharing group request generation module 322, a schedule consolidation module 324, a commuter assignment module 326, and a service disruption module 330. Additional functional components stored in the computer-readable media 386 may include an operating system 328 for controlling and managing various functions of the taxi sharing bridge system 110. Each of the modules may be executed by the one or more processors 304 of the taxis haring bridge system 110.

The database 350 may include volatile and nonvolatile memory and/or removable and non-removable media implemented in any type of technology for storage of information, such as computer-readable instructions, data structures, program modules, or other data. Such computer-readable media may include, but is not limited to, RAM, ROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. The storage interface 382 may provide raw data storage and read/write access to the database 350.

The database 350 includes, but is not limited to, a user information table 352, a master data table 354, a transit log table 356, a travel demand table 358, a service disruption table 360, a taxi sharing request table 362, a priority policy 364, and a service timetable 366. The modules will use the data stored in the database 350 and may update the data during execution, in combination with the processor(s) 304, which will be further described hereafter.

The taxi sharing bridge system 110 may also include or maintain other functional components and data not specifically shown in FIG. 3, such as other modules and data 332, which may include programs, drivers, etc., and the data used or generated by the functional components. Further, the taxi sharing bridge system 110 may include many other logical, programmatic and physical components, of which those described above are merely examples that are related to the discussion herein.

The communication interface(s) 302 may include one or more interfaces and hardware components for enabling communication with various other devices, such as over the network(s) 140, 150, and 161. For example, communication interface(s) 302 may enable communication through one or more of the Internet, cable networks, cellular networks, wireless networks (e.g., Wi-Fi) and wired networks (e.g., fiber optic and Ethernet), as well as close-range communications, and the like, as additionally enumerated elsewhere herein.

The taxi sharing bridge system 110 may further be equipped with various input/output (I/O) devices 306. Such I/O devices 306 may include a display, various user interface controls (e.g., buttons, joystick, keyboard, mouse, touch screen, etc.), audio speakers, connection ports and so forth. The taxi sharing bridge system may also be equipped with a management terminal 308 for an administrator to access directly or indirectly the I/O devices 306 so the administrator can manipulate settings of the taxi sharing bridge system such as certain thresholds, which are described later in more detail.

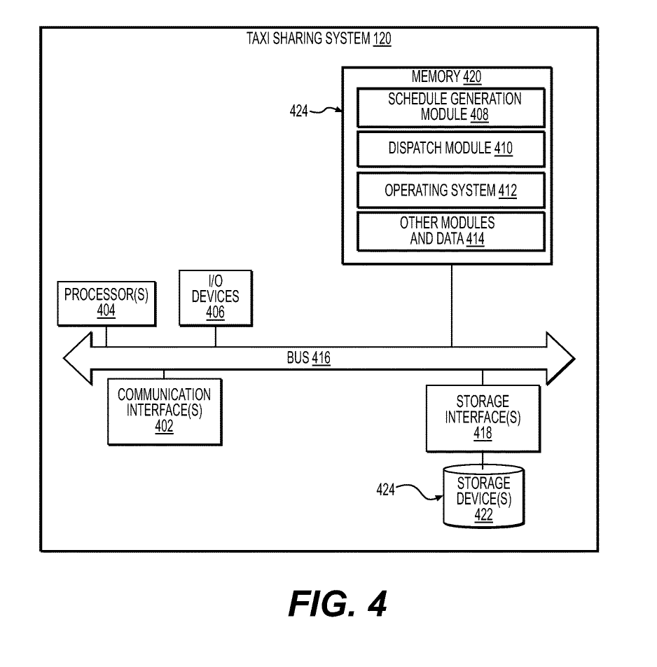

FIG. 4 illustrates a block diagram of one or more taxi sharing systems 120 according to some implementations. As mentioned above, the taxi sharing bridge system 110 communicates with one or more taxi sharing systems 120 to arrange, using the respective systems of the taxi sharing systems 120, taxis for the commuters who use the taxi sharing bridge system. The description and illustration of the select components in FIG. 4 illustrate one example of a taxi sharing system 120 although not every taxi sharing system 120 that the taxi sharing bridge system 110 communicates with has the illustrated configuration. One or more taxi sharing systems may be implemented in different ways.

A taxi sharing system 120 may include one or more servers or other types of computing devices that may be embodied in any number of ways. For instance, in the case of a server, the modules, other functional components, and data may be implemented on a single server, a cluster of servers, a server farm or data center, a cloud-hosted computing service, and so forth, although other computer architectures may additionally or alternatively be used. These components and data may alternatively be distributed across different computing devices and different locations in any manner. Consequently, the functions may be implemented by one or more service computing devices, with the various functionality described above distributed in various ways across the different computing devices. As mentioned above, multiple taxi sharing systems 120 may be located together or separately, and organized, for example, as virtual servers, server banks, and/or server farms. The described functionality may be provided by the servers of a single entity or enterprise, or may be provided by the servers and/or services of multiple different entities or enterprises.

In the illustrated example, each taxi sharing system 120 may include one or more processors 404, a memory 420, one or more communication interfaces 402, I/O device(s) 406, a storage interface 418, one or more storage devices 422, communication interface(s) 402 and a system bus 416. Each processor 404 may be a single processing unit or a number of processing units, and may include single or multiple computing units or multiple processing cores. The processor(s) 404 can be implemented as one or more microprocessors, microcomputers, microcontrollers, digital signal processors, central processing units, state machines, logic circuitries, and/or any devices that manipulate signals based on operational instructions. For instance, the processor(s) 404 may be one or more hardware processors and/or logic circuits of any suitable type specifically programmed or configured to execute the algorithms and processes described herein. The processor(s) 404 can be configured to fetch and execute computer-readable instructions stored in the computer-readable media 420, which can program the processor(s) 404 to perform the functions described herein. Data communicated among the processor(s) 404 and the other components may be transferred via the system bus 416 or other suitable connections.

The memory 420 and storage device(s) 422 are examples of computer-readable media 424. Such computer-readable media 424 may include volatile and nonvolatile memory and/or removable and non-removable media implemented in any type of technology for storage of information, such as computer-readable instructions, data structures, program modules, or other data. Such computer-readable media 422 may include, but is not limited to, RAM, ROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device.

The computer-readable media 424 may be used to store any number of functional components that are executable by the processors 404. In many implementations, these functional components comprise instructions or programs that are executable by the processors 404 and that, when executed, specifically configure the one or more processors 404 to perform the actions attributed to the taxi sharing systems 120. Functional components stored in the computer-readable media 420 may include a schedule generation module 408, and a dispatch module 410. Additional functional components stored in the computer-readable media 420 may include an operating system 412 for controlling and managing various functions of the taxi sharing system 120. A taxi sharing system 120 may also include or maintain other functional components and data not specifically shown in FIG. 4, such as other modules and data 414, which may include programs, drivers, etc., and the data used or generated by the functional components. Further, the taxi sharing system 120 may include many other logical, programmatic and physical components, of which those described above are merely examples that are related to the discussion herein. The modules may be executed by the processor(s) 404 of the taxi sharing system. The storage interface 418 may provide raw data storage and read/write access to the storage device(s) 422.

The communication interface(s) 402 may include one or more interfaces and hardware components for enabling communication with various other devices, such as over the network(s) 150. For example, communication interface(s) 402 may enable communication through one or more of the Internet, cable networks, cellular networks, wireless networks (e.g., Wi-Fi) and wired networks (e.g., fiber optic and Ethernet), and the like, as additionally enumerated elsewhere herein.

The taxi sharing system 120 may further be equipped with various input/output (I/O) devices 406. Such I/O devices 406 may include a display, various user interface controls (e.g., buttons, joystick, keyboard, mouse, touch screen, etc.), audio speakers, connection ports and so forth.

In general, commuters who use the public transportation service and who are registered with the taxi sharing bridge system use their client devices 130 to receive and send information with the taxi sharing bridge system 110. The taxi sharing bride system 110 manages registered commuters and their travel demand. The travel demand indicates the route the commuter typically takes to get from an origin station to a destination during a trip on a particular day, for example. A commuter may have more than one trips in a day depending on how often the commuter uses the public transportation system. A trip from an origin to a destination may have more than one route.

The data used to develop a commuter's travel demand is the transit logs of the commuter which are recorded in accordance with the commuter's transit card. Each commuter typically has a transit card that when used allows information such as time, date, and location of travel to be recorded. The card has a unique ID, which associates the commuter with the transit ID card. The taxi sharing bridge system 110 acquires the data and is able to generate a travel demand for reach commuter, which is explained below. When a travel disruption occurs, the travel demand information and the disruption information can be compared to determine whether a commuter is affected by the disruption. If the commuter is affected then a message is sent to the client device of the commuter to confirm whether the commuter would like to use the taxi sharing bridge system service to obtain a taxi for the commuter, which may involve grouping the commuter with other commuters to take one taxi. If the commuter decides to use the service, the client device communicates with the taxi sharing bridge system 110, using the client device application or otherwise, to confirm that the commuter would like to use the taxi sharing service.

Based on a priority policy, which is described below, the commuter is grouped with other commuters based on their origin, destination, and gender. The taxi sharing bridge system communicates with a plurality of taxi sharing systems to initiate the generation of a taxi sharing schedule by each taxi sharing system. The taxi sharing bridge sharing system then receives a taxi sharing schedule from each taxi sharing system and merges the schedule. Subsequently commuters are assigned to taxis and the commuters are informed of the assignment. In addition, assignment information is sent to respective taxi sharing systems so each taxi sharing system may dispatch their own taxis according to their protocol.

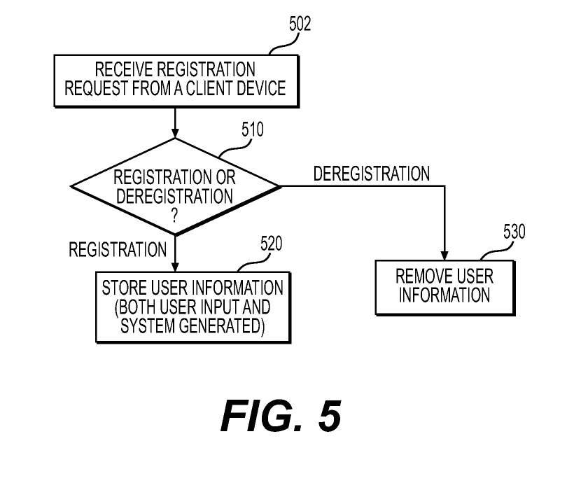

FIG. 5 is a flow diagram illustrating an example process for registering a user of the taxi sharing bridge system according to some implementations. The registration module 312 of the taxi sharing bridge system 110 may execute the process and algorithm structure of FIG. 5. In step 502, the taxi sharing bridge system 110 receives a registration request from a client device 130. The taxi sharing bridge system 110 determines if the request is to register a new user or deregister an existing user. If it is to register a new user, in step 520, the system stores user information (both user input and system generated) to a user information table 352. If the request in step 510 is to deregister an existing user, in step 530, the system removes the user from the user information table 352. Only registered commuters can use the taxi sharing bridge service.

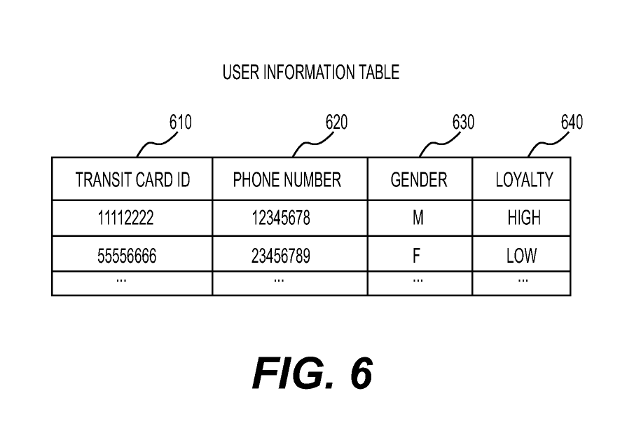

FIG. 6 illustrates an example of a user information table 352 according to some implementations. The user information table 352 stores information of a plurality of commuters and consists of, but is not limited to, 4 columns, including a transit card ID 610, a phone number 620, a gender 630 (Male or Female), and a loyalty 640. Transit card ID 610, phone number 620 and gender 630 are input by the user using the client device 130. The user information table 352 is stored in the database 350 and is accessed by the taxi sharing bridge system 110. This information may be sent to the taxi sharing bridge system 110. The transit card ID 610 is a unique ID assigned to a transit card used by a commuter when taking public transportation service, such as EZ-Link card in Singapore or SUICA in Japan. An example of a transit card is a smart card, contactless smart card or any other way of identifying a commuter when the commuter uses a particular public transportation service. A transit ID card may use RF technology to communicate at a reader, which is typically at a gate or other location within a terminal of a station (i.e., train or bus station).

A phone number may be a unique number assigned to a client device 130 where a client application 214 is installed. In the alternative, another unique identification number could be used such as one assigned to an application 214 existing on the client device 130 for receiving and sending communications to and from the taxi sharing bridge system 110. The value of a gender 630 is either M (Male) or F (Female). A loyalty 640 is generated and dynamically updated by the system. For instance, a commuter may have higher loyalty if the commuter accepts to use the taxi sharing bridge service more often than other commuters, or if the commuter uses the public transportation service more often than other commuters.

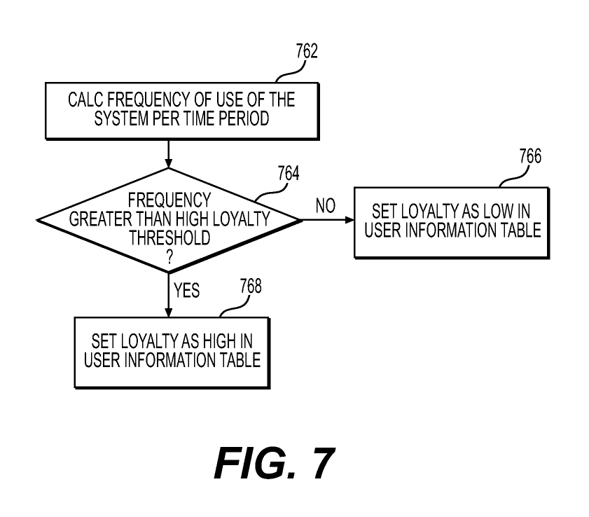

FIG. 7 is a flow diagram illustrating an example process for determining a user's loyalty status according to some implementations. In general, the taxi sharing bridge system 110 may execute the process and algorithm structure of FIG. 7. In step 762, by accessing data stored within the database 350, the frequency that a particular user uses the taxi sharing bridge system is calculated based on a predetermined time period (e.g., week, month, year). The data may indicate when a user uses the taxi sharing bridge system 110. If, in step 764, the frequency exceeds a predetermined loyalty threshold (e.g., greater than 80%), then the loyalty 640 is set to “high” in the user information table 352 (in step 768). If the frequency is not greater than the predetermined loyalty threshold than in step 766, the loyalty 640 for the user is set to “low” in the user information table 352. In this manner, the loyalty 640 of each user can be calculated. In the alternative, instead of using the frequency of use of the taxi sharing bridge system by a commuter in step 764, the system can use the frequency of use of a commuter of a public transportation system by determining the frequency according to the transit logs of the commuter. In addition, the frequency can be calculated based on how often a user uses the system (or transportation system) relative to the other users. For example, a user in the top 20% of all users may be given a high loyalty status.

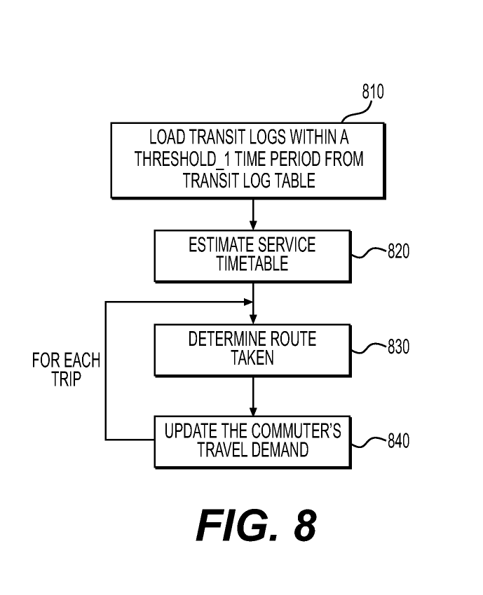

FIG. 8 is a flow diagram illustrating an example process for determining a commuter's travel demand according to some implementations. The travel demand modeling module 314 of the taxi sharing bridge system 110 may execute the process and algorithmic structure of FIG. 8. The process is executed periodically (e.g., daily, weekly, monthly). A travel demand of a commuter is updated and stored in the travel demand table 358 for each commuter. The travel demand indicates the usual trip a commuter takes on a given day. For example, from an origin station (e.g., train station near the commuter's home) within a given start time to a destination station (e.g., train station near the commuter's office) on a given day. The contents of the travel demand table 358 is discussed in more detail below. A travel demand table 358 is initially established for a commuter after the commuter registers with the system so it may be updated.

In step 810, the taxi sharing bridge system 110 loads the transit logs within a predefined threshold (e.g., threshold_1) from a transit log table 356, which consists of all the transit logs recorded in accordance with each commuter's transit card. Threshold_1 is a time period, such as one day. In some cases, the predefined threshold may be chosen from one of a set of days, such as a weekday (i.e., Monday-Friday) or weekend (Saturday or Sunday).

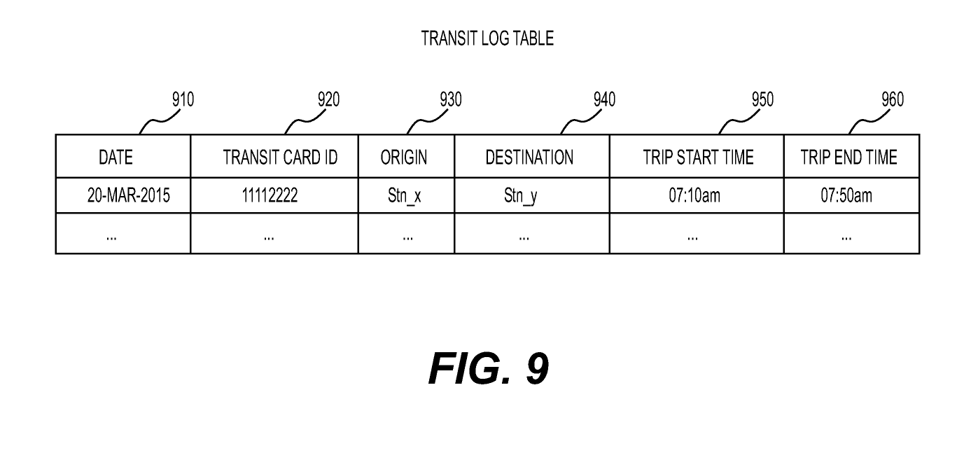

FIG. 9 shows an example of the structure of a transit log table 356. The transit log table 356 is obtained from the public transportation system 160 over the one or more networks 161 and stored in the database 350. The transit log table 356 consists of, but is not limited to, 6 columns, including a date 910, a transit card ID 920, an origin 930, a destination 940, a trip start time 950, and a trip end time 960. The data within the transit log table 356 may be sorted according to at least the date 910, transit card ID 920, origin 930, or destination 940 columns. The date 910 is the date when the transit occurred using a transit card with a transit card ID 920. The origin 930 is the starting station where the commuter starts the trip at a trip start time 950, which is recorded using the transit card technology when the commuter uses the transit card at the gate of the station. The destination 940 is the end station where the commuter ends the trip at a trip end time 960, which is recorded by the transit card technology when the commuter exits the destination station 940. The destination station 940 refers to the last station of the public transportation service that the commuter uses during the trip even though the commuter may pass through many stations and there may be multiple lines, paths, or routes to travel from the origin 930 to the destination 940. In the example shown in FIG. 9, a commuter having the transit card ID of 11112222 traveled from origin train station “Stn_x” to destination station “Stn_y” on Mar. 20, 2015. The time when the transit card was used at the origin station was 7:10 am and the time when the transit card was used at the destination station was 7:50 am.

Referring back to FIG. 8, in step 820, the system estimates the public transportation service timetable. The service timetable is estimated by analyzing the data loaded from the transit log table 356 in step 810. By analyzing the destination 940 and the trip end time 960 of the transit logs, the arriving time of the service (e.g., train) at each station can be estimated. For a given station (e.g., destination station 940), the transit logs indicate an end time 960. From an end time 960, the average walking time (time it takes on average) from the platform to the gate of the station may be subtracted to estimate the time of arrival of the service (e.g., train) to the station. This may be determined for respective end times of a station to estimate the timetable of the station. Accordingly, the timetable for each station can be estimated. For example, if there are one or more commuters that arrive at destination station Stn_Y, then the trip end time 960 of these commuters may be analyzed to determine the time that the service arrived to station Stn_Y, by considering the average walking time from the platform of the station to the exit gate of the station. The average walk time from a platform to a gate of a station may be previously stored and known to the taxi sharing bridge system 110 and may be stored in the master data table. In this manner, the timetable of each line of the transportation service may be estimated. The estimated transportation timetable is stored in the service timetable 366.

In step 820, instead of estimating the public transportation service timetable, the actual timetable (i.e., schedule) of the public transportation service may be obtained from the public transportation system 160. The data of the actual timetable of the service may be obtained from the public transportation system 160 or from the public domain (such as the published schedule). The actual timetable may be stored in the service timetable 366.

After the service timetable is estimated (or obtained) in step 820, the process continues to determine the route taken for each trip of an individual commuter in step 830 within the threshold_1 time period. As mentioned, there may be one or more routes for a commuter to travel from an origin to a destination of a trip. The route may involve transferring to different lines, for example. The possible routes for using the public transportation system to travel from an origin station to a destination station are previously known and stored in a master data table 354. This information includes the service line of the route 1030.

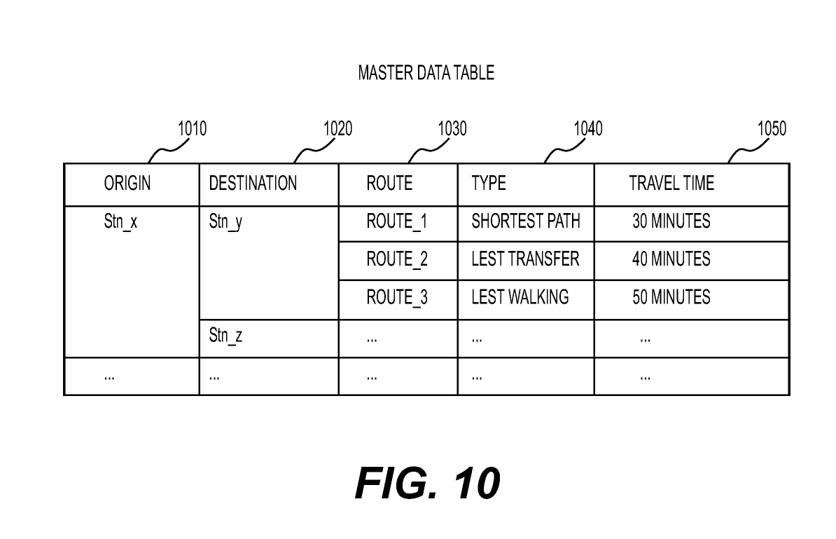

FIG. 10 illustrates an example of a master data table 354 according to some implementations. The master data table 354 consists of, but is not limited to, 5 columns, including an origin 1010, a destination 1020, a route 1030, a type 1040, a travel time 1050. As mentioned above, from an origin station 1010 to a destination 1020, multiple routes 1030 may exist, for instance, by taking different train service lines, and route 1030 may have different travel times 1050. A type 1040 represents the characteristic of a route 1030, such as a shortest path between the origin 1010 and destination 1020. Another example is a route 1030 that has fewer transfers designated as “lest transfer”, or a route 1030 that requires a commuter to walk less compared to other routes for the trip, is given the designation “lest walking.” These types are examples and routes may be designated according to other types. Accordingly, the stations along each route are previously stored (known) and can be determined by the taxi sharing bridge system 110. The type 1040 is a characteristic given to a route 1030. The type 1040 characteristic can be either generated by the taxi sharing bridge system 110 using the characteristics of the route 1040 or can be input by an administrator. The data included in the origin 1010, destination 1020, route 1030, and 1040 columns is previously determined and stored in the master data table 354. Although not shown in FIG. 10, the master data table 354 may also include data indicating a number of transfers for a route 1030 and a walking time.

For each trip taken by a commuter, the commuter's travel time is calculated using the data of the trip start time 950 and trip end time 960 from the transit log 356. The travel time is the duration of time from the trip start time 950 to the trip end time 960. In step 830, the origin 930 and destination 940 for the commuter's trip is compared with the master data table 354 and the route 1030 the commuter took during a trip is determined by comparing the calculated travel time with the travel time 1050 stored in the master data table 354. For example, if the calculated travel time for traveling from origin station x (Stn_x) to destination station y (Stn_y) is 30 minutes (or within a predetermined variance threshold, for example 2 minutes, to the travel time 1050), then it can be determined that the commuter travelled according to Route_1 of the routes 1030. From the master data table 354, the type 1040 of the route is also determined. Using the above example, the commuter took the route having the type 1040 “shortest path,” which corresponds to Route_1. As mentioned above, each trip for the commuter in step 830 is compared to determine which route the commuter took for the trip. At step 840, the system updates the commuter's travel demand table.

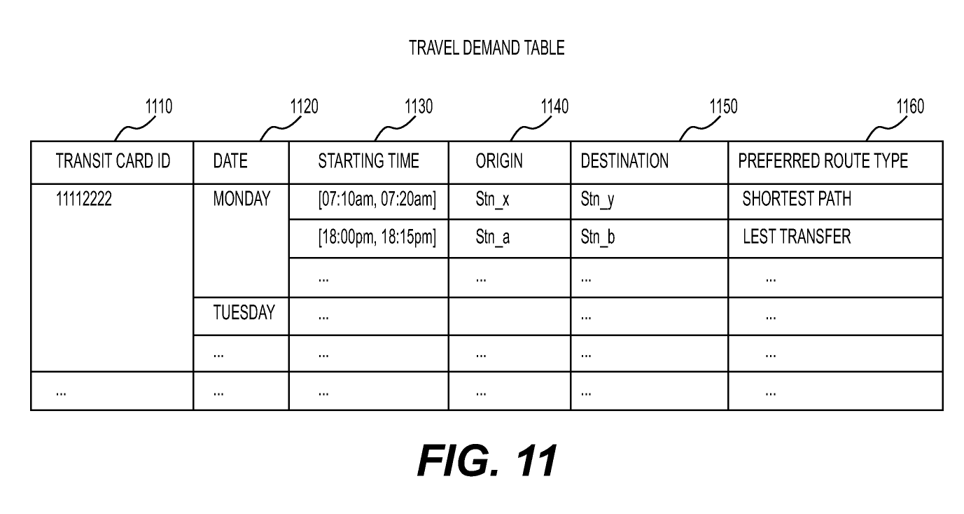

FIG. 11 shows an example of a travel demand table 358 according to some implementations. The travel demand table 358 consists of, but is not limited to, 6 columns, including a transit card ID 1110, a date 1120, a starting time 1130, an origin 1140, a destination 1150, and a preferred route type 1160. The starting time 1130 is a time range, in which a commuter with the transit card ID 1110 has traveled from the origin station 1140 to destination station 1150. The time range is determined by analyzing the trip start times 950 to determine what time period the commuter traveled most on a specific day, such as Monday.

The date 1120 is week-based, from Monday to Sunday. The weekday may be known by comparing the date of the transit log with calendar information. For example on a Monday, the commuter having transit card ID 11112222 has a starting time 1130 between 7:10 am and 7:20 am. The preferred route type 1160 is determined based on the travel history of the commuter in a time period (for example, 6 months or 1 year). For instance, in the given time period, the taxi sharing bridge system 110 determines which route 1030, out of Route_1, Route_2, or Route_3, the commuter took most often. After processing the above, the travel demand table 358 is updated for the commuter.

When a disruption occurs on a public transportation service many commuters are affected. A disruption may prevent many commuters from using the public transportation service to travel from their origin station to the destination station. As a result, the commuters must find an alternative mean for transportation, such as a taxi. The following describes the processing for how the taxi sharing bridge system 110 communicates with the client devices 130, public transportation system 160, and taxi sharing systems 120 to send client devices 130 information indicating a taxi and the number of commuters assigned to each taxi so the taxi may take one or more of the commuters to their destination station or other location near the destination station.

When a disruption occurs in the public transportation system, the public transportation system 160 sends data indicating disruption information over the one or more networks 161 to the taxi sharing bridge system 110.

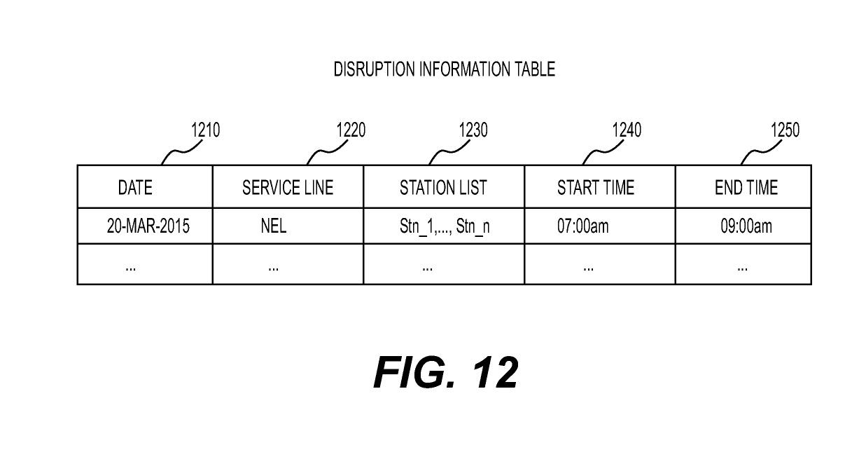

FIG. 12 illustrates an example of a disruption information table according to some implementations. Service disruption information may be stored in a table 360 in the database 350. The service disruption information consists of, but is not limited to, 5 columns, including a date 1210 in which a disruption occurs, a disrupted service line 1220, a station list 1230 which consists of a list of stations affected due to the service disruption, a disruption start time 1240, and a disruption end time 1250 which may be estimated by an operator of the public transportation system.

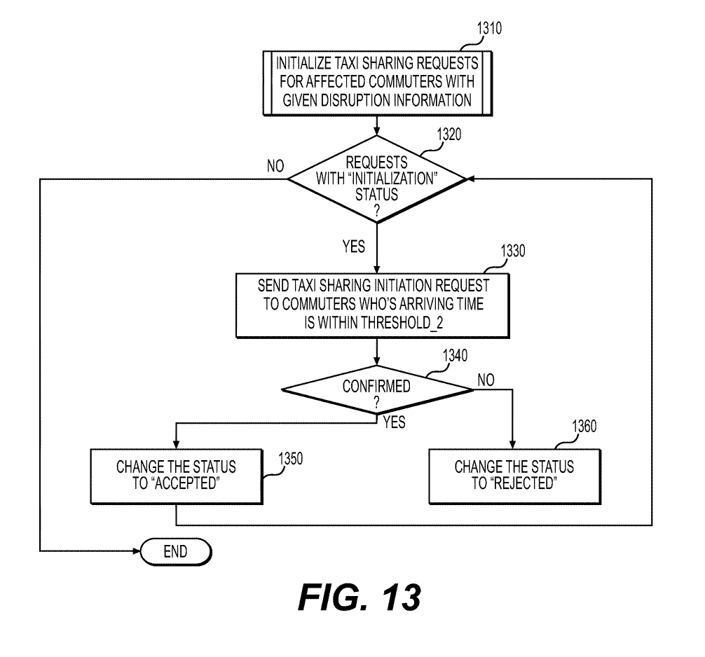

FIG. 13 is a flow diagram illustrating an example process for consolidating the travel demand according to some implementations. The demand consolidation module 316 of the taxi sharing bridge system 110 may execute the process and algorithm structure of FIG. 13. The processing begins when the system 110 receives disruption information from the public transportation system 160. In some instances, the demand consolidation module 316 determines a taxi sharing request (described below) for a commuter, which consolidates the information pertaining to that commuter.

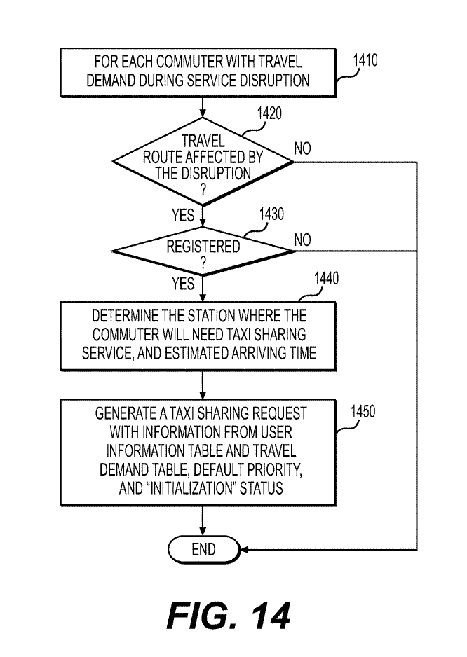

After the system 110 receives disruption information and stores the disruption information in the database 360, step 1310 is executed. Step 1310 initializes taxi sharing requests for commuters affected by the disruption, who are determined based on the disruption information. The processing of step 1310 is illustrated in FIG. 14.

FIG. 14 is a flow diagram illustrating an example process for generating a taxi sharing request according to some implementations. In step 1410, the travel demand tables 358 of each commuter are searched to identify all of the commuters having a travel demand during the service disruption. In some instances, the system may identify all commuters that have a travel time period indicated by a starting time 1130 (a start time within the range of starting time 1130) and an end time of travel that overlaps with the disruption time period of the disruption indicated by the start time 1240 of the disruption information and the end time 1250 of the disruption information. The end time of travel may be calculated based on the travel time 1050 for the given route 1030 the commuter takes.

Then, for each of the commuters found in step 1410, the system searches the travel demand table 358 in step 1420 to determine if the commuter's travel route 1030 of the preferred travel route type 1160 is affected by the disruption. The system compares the service line 1220 information in the disruption information with the travel route 1030 of each commuter to determine whether the route 1030 includes the service line 1220 of the disruption information. If, the route includes the service line affected 1220, the system then compares the stations in the station list 1230 with the stations in the travel route 1030 to determine if the commuter is affected by the disruption. For example, if a station in the station list 1230 is a station along a route 1030, then the system may determine a commuter is affected.

If the commuter is affected by the disruption (yes in step 1420), then the system determines if the commuter is registered to use the taxi sharing bridge system by searching the user information table 352 for the transit card ID 610 of the affected commuter. If yes, in step 1430, the system then determines the station where the commuter will need a taxi in step 1440. For instance, the station where the commuter will need a taxi may be the first station in the commuter's preferred travel route that is affected by the disruption based on the stations list 1230 in the disruption information table. The system can compare the stations in the disruption information to the stations along the preferred route to determine which station is first affected.

The system then estimates the commuter's arriving time to the determined station based on the trip start time 1130 from the commuter's travel demand table. For instance the system determines, based on the estimated service timetable, when the commuter will arrive to the affected station.

In step 1450, the system generates a taxi sharing request for the commuter with corresponding information from user information table 352 and travel demand table 358, default priority, and status as “Initialization”. If no in Step 1420 or 1430, the system will skip the current commuter and check the next commuter of the commuters found in step 1410.

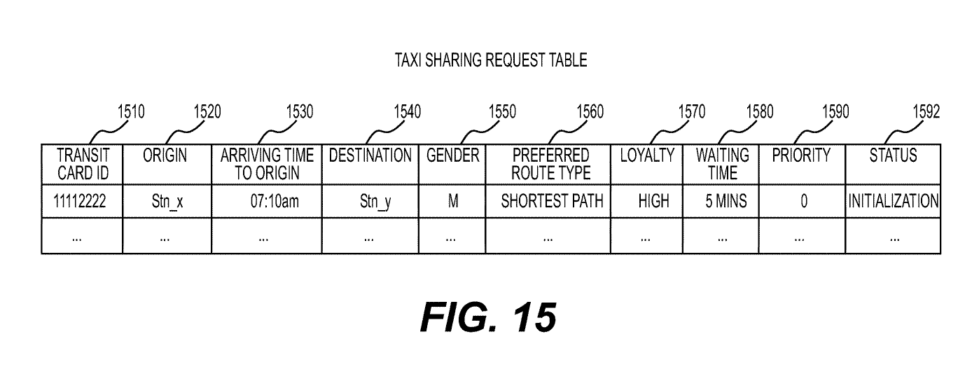

FIG. 15 illustrates an example of a taxi sharing request table according to some implementations. The taxi sharing request table 362 is stored in the database 350 and consists of, but is not limited to, 10 columns, including a transit card ID 1510, an origin 1520, an arriving time to origin 1530, a destination 1540, a gender 1550, a preferred route type 1560, a loyalty 1570, a waiting time 1580, a priority 1590, and a status 1592. The origin 1520 is a station where the commuter may need the taxi sharing service calculated in step 1440. The arriving time to origin 1530 is the earliest time that a commuter may arrive at the origin 1520 calculated in step 1440.

The waiting time 1580 is the time (in minutes) a commuter has been waiting at the origin station 1520. It may be noted that the value of a waiting time can be less than 0, if the current system time is before the commuter arriving time 1530. A priority 1590 has default value as “0”, and may be updated to a higher value by the system (e.g., within priority update module 320), which will be further explained hereafter. The value of a status 1592 may be “Initialization”, “Accepted”, “Rejected”, “Assigned”, and “Retry”.

Referring back to FIG. 13, in step 1320, the system checks if there are taxi sharing requests with “Initialization” status. For each taxi sharing request with “initialization” as the status, in step 1330, the system sends a taxi sharing initiation request to commuters who's arriving to origin time 1530 is within a predefined threshold, threshold_2 (e.g., 10 minutes), and waits for the confirmation from commuters in step 1340.

The taxi sharing initiation request is sent to the client device 130 of the commuter over the one or more networks 140. The request may be in the form of an SMS, email, call, application notification, or any other notification. The taxi sharing initiation request may be displayed as a guided user interface (GUI) on the client device 130. The contents of the request consists of, but is not limited to, the destination 1540, the origin station 1520, and a request for the commuter receiving the taxi sharing initiation request to accept or reject the use of a taxi sharing service via their client device. The request may be a text field, button field or the like. The response to the request from the commuter is sent to the taxi sharing bridge system, and step 1340 determines whether the response is acceptance (yes in step 1340) or rejection (no in step 1340).

If a commuter accepts to use the taxi sharing service from the origin 1520, in step 1350, the taxi sharing request status will be changed to “Accepted”. When, in step 1340, a commuter decides to use the taxi sharing bridge system, the instance is recorded in a table in the database 350 along with the date the commuter used the system. If a commuter does not accept to use taxi sharing service, then in step 1360, the taxi sharing request status 1592 will be changed to “Rejected.”

Once the system 110 has determined which commuters accept using a taxi sharing service, the priority 1590 in the taxi sharing request table for those commuters is determined.

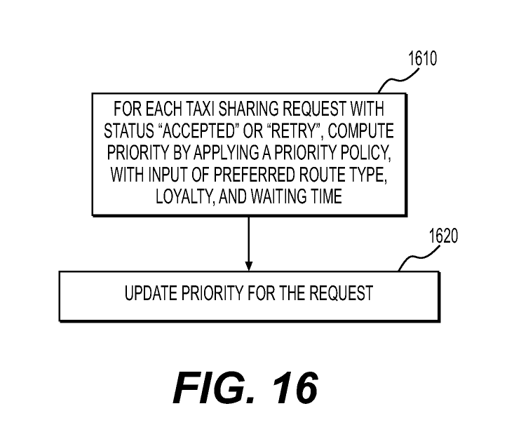

FIG. 16 is a flow diagram illustrating an example process for updating a priority of a commuter according to some implementations. The priority update module 320 of the taxi sharing bridge system 110 may execute the process and algorithm structure of FIG. 16. The priority update process is executed for each taxi sharing request having a status of “Accepted” or “Retry”. In step 1610, the system computes the priority of a commuter by applying a priority policy stored in the database in priority policy 364. In step 1620, the system then updates the taxi sharing request with the calculated priority value for the commuter (priority 1590 of FIG. 15). Various priority policies 364 may be defined based on commuter's preferred route type 1560, loyalty 1570, waiting time 1580, or any combination thereof. The policy depicted herein is an example.

For instance, a commuter with a longer waiting time 1580 at a station can have a higher priority than another commuter with a shorter waiting time 1580. In another instance, priority value 1590 may be calculated based on the preferred route type 1560 of a commuter. If a commuter prefers a “shortest path” route type, it may indicate that travel time is more critical for the commuter. Whereas, if a commuter prefers “less transfer” route type, it may indicate that the commuter is looking for a more comfortable service even if the travel time is longer. Therefore, a commuter whose preferred route type is “shortest path” can have a higher priority than another commuter whose preferred route type is “less transfer”. Similarly, a higher priority may be set for commuters with higher loyalty, to reward the commuters who often take public transportation service or who often use the taxi sharing bridge system. On the other hand, higher priority may be set for commuters with lower loyalty, if the service operator wants to promote public transport service to those commuters who do not often take public transport service, for example.

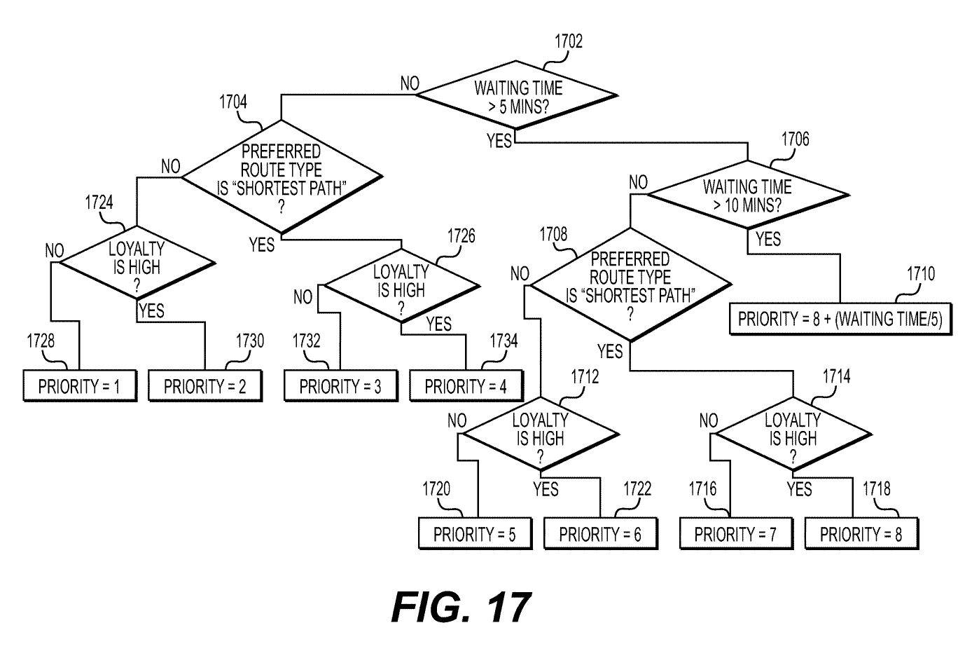

FIG. 17 is a flow diagram illustrating an example process for updating a commuter's priority according to some implementations. The priority policy configuration module 318 of the taxi sharing bride system 110 executes the process and algorithm structure of FIG. 17. The priority policy may be updated by the system administrator. It may be noted that a plurality of priority policies 364 can be stored and the system may dynamically change the current priority policy based on other information, for instance, based on seasons. It may be also noted that a priority policy may be defined with information not limited to preferred route type 1560, loyalty 1570, and waiting time 1580. The aforementioned examples are only provided for ease of understanding.

According to the exemplary priority policy of FIG. 17, in step 1702, a commuter's waiting time 1580 is considered. If the waiting time 1580 is greater than 5 minutes (yes in step 1702), then step 1706 is executed to determine whether the waiting time is greater than 10 minutes. If the waiting time is greater than 10 minutes (yes in step 1706), then at step 1710, the priority 1590 for the commuter is set to: 8+(waiting time)/5). The minute value of the waiting time 1580 may be divided by 5 to determine the priority. For instance if the waiting time 1580 of the commuter is 20 (20 minutes), then the priority value for the commuter is set to 12.

In step 1708 if the waiting time is not greater than 10 minutes (no in step 1706) then the preferred route type 1560 of the commuter is considered. In step 1708 if the preferred route type 1560 is “shortest path” (yes in step 1708), then the loyalty 1570 of the commuter is considered in step 1714. If the loyalty 1570 of the commuter is “high” then the priority 1590 is set to 8 in step 1718. If the loyalty 1570 is not “high” (no in step 1714), then the priority 1590 is set to 7 in step 1716. If in step 1708 the preferred route type 1560 is not “shortest path” (no in step 1708), then the loyalty 1570 of the commuter is considered in step 1712. If the loyalty 1570 of the commuter is “high” (yes in step 1712), then the priority 1590 is set to 6 in step 1722. If the loyalty 1570 is not “high” (no in step 1712), then the priority 1590 is set to 5 in step 1720.

In step 1702, if the evaluation of the waiting time 1580 of a commuter is not greater than 5 minutes (no in step 1702), then the preferred route type 1560 of the commuter is considered in step 1704. In step 1704 if the preferred route type 1560 is “shortest path” (yes in step 1704), then the loyalty 1570 of the commuter is considered in step 1726. If in step 1726 the loyalty 1570 of the commuter is “high” (yes in step 1726), then the priority 1590 is set to 4 in step 1734. On the other hand, if the loyalty 1570 of the commuter is not “high” (no in step 1726), then the priority 1590 is set to 3 in step 1732.

If in step 1704 the preferred route type 1560 is not “shortest path” (no in step 1704), then the loyalty 1570 of the commuter is considered in step 1724. In step 1724, if the loyalty 1570 is “high” (yes in step 1724), then the priority 1590 is set to 2 in step 1730. If, in step 1724 the loyalty 1570 is not “high” (no in step 1724), then the priority 1590 of the commuter is set to 1 in step 1728.

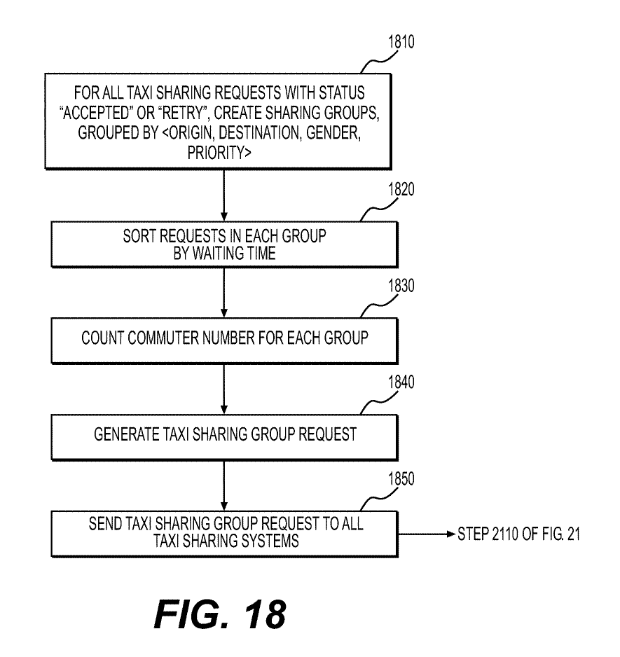

FIG. 18 is a flow diagram illustrating an example process for generating a taxi sharing group request according to some implementations. The taxi sharing group request generation module 322 may execute the process and algorithm structure of FIG. 18. In general, the individual taxi sharing requests are grouped so the groups can be sent to each taxi sharing system 120. The processing of the generation of the taxi sharing group request is executed periodically (for example, every minute).

In step 1810, sharing groups are created based on all taxi sharing requests, stored in taxi sharing request table 362, with a status of “Accepted” or “Retry.” The taxi sharing requests are grouped based on origin 1520, destination 1540, gender 1550, and priority 1590. In step 1810, the requests are grouped by origin 1520, followed by destination 1540, gender 1550, and priority 1590. In addition, a group ID 1950 is an ID assigned to each sharing group. In step 1820, the system sorts the requests in each group by the commuter waiting times 1580.

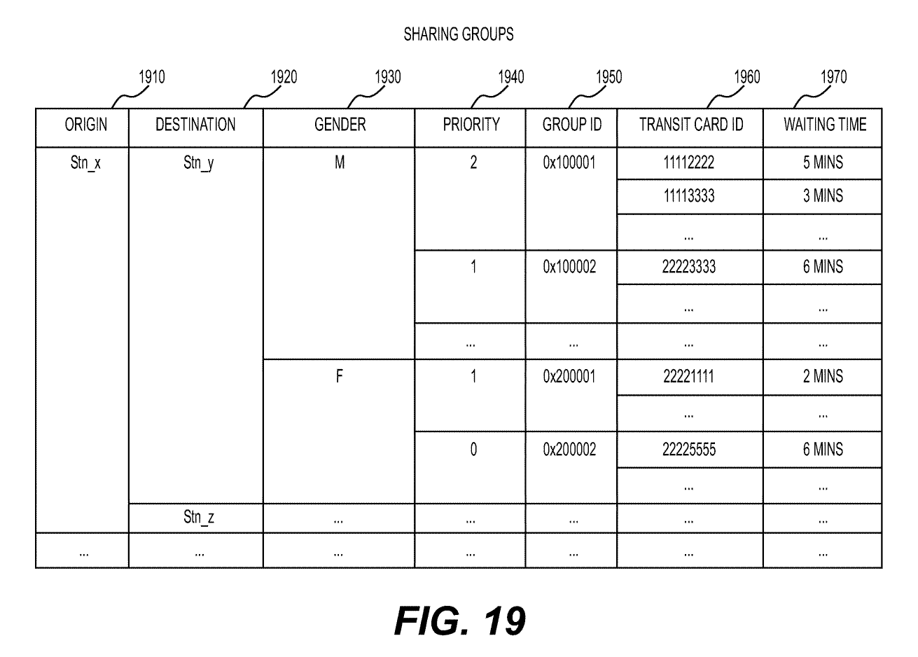

FIG. 19 illustrates an example of a sharing group according to some implementations. The sharing groups consist of, but are not limited to, 7 columns, including an origin 1910, a destination 1920, a gender 1930, a priority 1940, a group ID 1950, a transit card ID 1960, and a waiting time 1970. Each sharing group consists of a plurality of commuters with same origin 1910, destination 1920, gender 1930, priority 1940, and sorted by waiting time 1970 (the same as waiting time 1580 in taxi sharing request table 362). The origin 1910 is the same as origin 1520 of FIG. 15.

Referring back to FIG. 18, in step 1830, the system counts the number of commuters in each group having a group ID 1950. Subsequently, a taxi sharing group request is generated in step 1840. In step 1850 the system 110 sends the taxi sharing group request(s) to all taxi sharing systems 120 over the one or more networks 150.

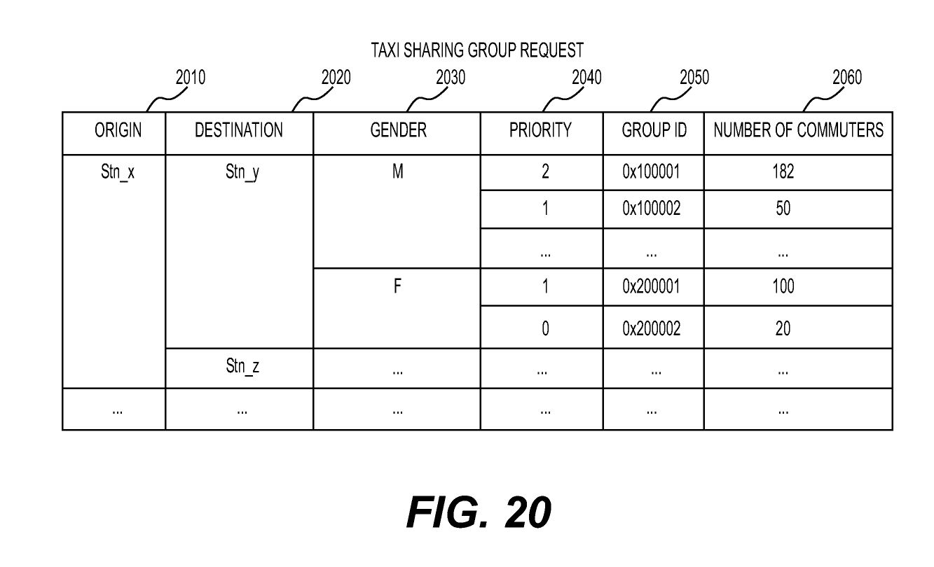

FIG. 20 illustrates an example of a taxi sharing group request according to some implementations. A taxi sharing group request consists of, but is not limited to, 6 columns, including an origin 2010, a destination 2020, a gender 2030, a priority 2040, a group ID 2050, and a number of commuters 2060 in a group. The information of the taxi sharing group request is consistent with the data of the sharing groups in FIG. 19. As shown, there is a group ID 2050 for each group having the same priority 2040, gender 2030, destination 2020, and origin 2010.

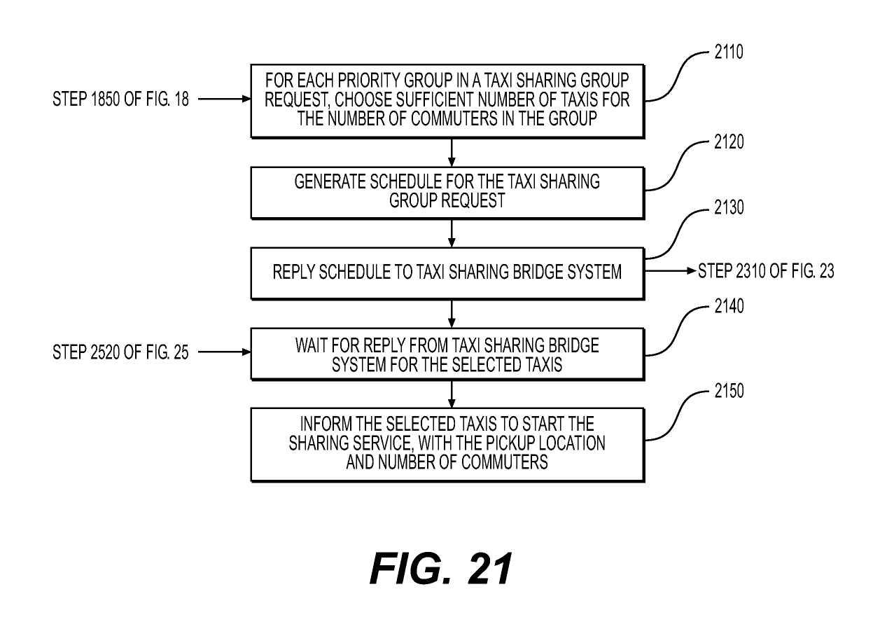

FIG. 21 is a flow diagram illustrating an example process executed by one or more taxi sharing systems according to some implementations. The schedule generation module 408 of a taxi sharing system 120 may execute the process and algorithm structure of FIG. 21.

As mentioned above, each taxi sharing system is a system that communicates with many taxis. Taxi sharing systems are well known in the art and therefore the details of a taxi sharing system will not be explained here.

Each taxi sharing system 120 receives a taxi sharing group request. In step 2110, for each priority group in a taxi sharing group request, a sufficient number of taxis for the number of commuters 2060 in the group are determined. Each taxi sharing system 120 may use different methods that can be found in existing arts to choose their taxis. For instance, if a group has 50 commuters (number of commuters 2060), then the taxi sharing system will arrange as many taxis as possible for 50 commuters (for example, 13 taxis, if each taxi can take 4 commuters). It may be noted that a taxi sharing system 120 should arrange as many taxis as possible to serve the number of commuters 2060 in a priority group with higher priority, before arranging taxis for groups with lower priority. For each group (Group ID 2050), individual taxis are arranged that each have a passenger capacity. The taxi sharing system manages the pickup location of each taxi and the estimated arrival time of each taxi. In step 2120, each taxi sharing system generates a schedule with the chosen taxis for the taxi sharing group request, which includes the above information.

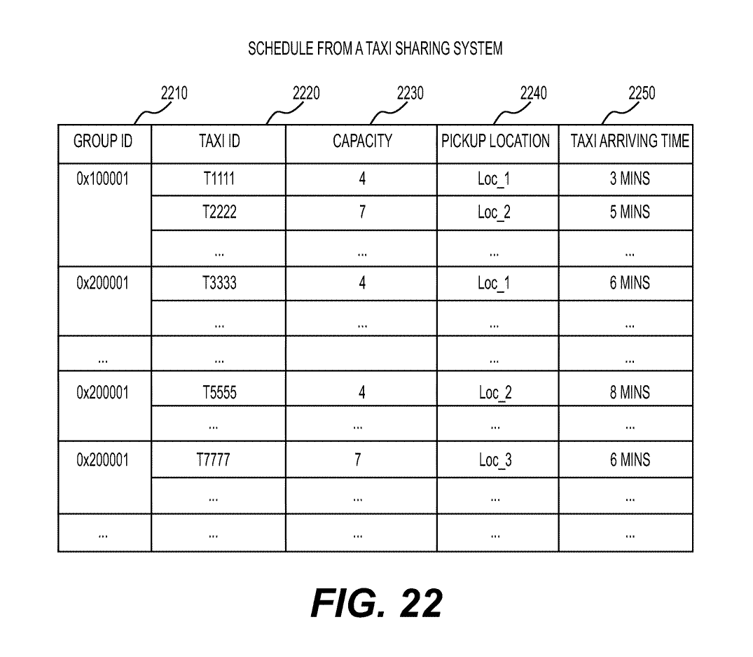

FIG. 22 illustrates an example of a schedule from a taxi sharing system according to according to some implementations. The schedule generated by a taxi sharing system 120 consists of, but is not limited to, 5 columns, including a group ID 2210, a taxi ID 2220, a capacity 2230, a pickup location 2240, and a taxi arriving time 2250. A taxi ID 2220 is a number assigned for an individual taxi. A capacity 2230 is the maximum number of commuters the individual taxi can carry. The taxi arriving time 2250 is the waiting time for the taxi to arrive the pickup location 2240. The pickup location 2440 is based on the origin 2010 of a sharing group request.

Referring back to FIG. 21, in step 2130, each taxi sharing system replies their generated schedule to the taxi sharing bridge system 110 over the one or more networks 150.

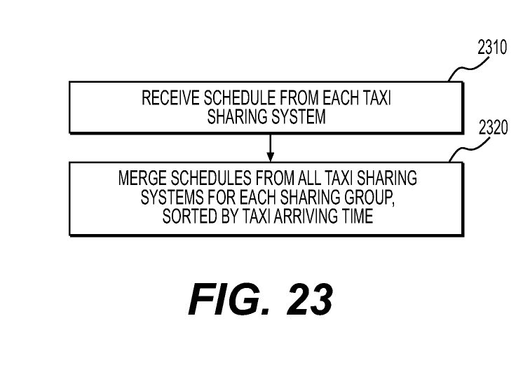

FIG. 23 is a flow diagram illustrating an example process for consolidating schedules from one or more taxi sharing systems according to some implementations. The schedule consolidation module 324 of the taxi sharing bridge system 110 may execute the process and algorithm structure of FIG. 23.

The schedule consolidation process is executed after the taxi sharing bridge system 110 sends a taxi sharing group request in step 1850 to each of the taxi sharing systems 120. In step 2310, the system 110 receives a schedule from each taxi sharing system 120 that received a taxi sharing group request. In step 2320, the system merges schedules from all the taxi sharing systems 120 for each sharing group and sorts the merged schedules by taxi arriving time 2460.

The system 110 assigns each taxi sharing system an identifier, such as taxi sharing system ID 2420. As mentioned above, each taxi sharing system 120 replies with the taxis 2430 arranged for each group 2410. The system in step 2320 considers all of the taxis from each of the taxi sharing systems 120 in each group and selects, in order of the taxis having the shortest taxi arriving time 2250, the taxis that will be assigned to that group based on the number of commuters 2060 in the group and the cumulative capacity of the taxis. For example, if the number of commuters 2060 in the group is 50, then the system 110 selects a number of taxis so that the sum of the capacity 2230 of the taxis in the group is greater than or equal to the number of commuters 2060 in the group. Each taxi is chosen, among the taxis arranged in all of the taxi sharing systems 120, based on the taxi arriving time. The taxi having the shortest taxi arriving time for a group is selected as the next taxi in the merged schedule.

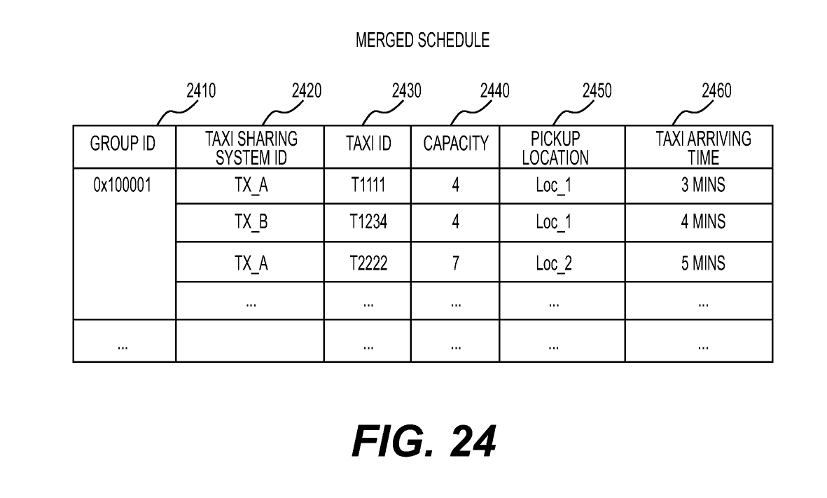

FIG. 24 illustrates an example of a merged schedule according to according to some implementations. The merged schedule consists of, but is not limited to, 6 columns, including a group ID 2410, a taxi sharing system ID 2420, a taxi ID 2430, a capacity 2440, a pickup location 2450, and a taxi arriving time 2460. Each group consists of taxis from a plurality of taxi sharing systems 120, which are sorted by the estimated arriving time 2460 of a taxi to a particular pickup location 2450. The pickup locations 2450 are locations near or at the origin station 2010 of the group. For example, Loc_1 in FIG. 24 may be a location at or near the origin station 2010 of the taxi sharing group request. The taxi sharing system ID 2420 is the identification of the taxi sharing system 120.

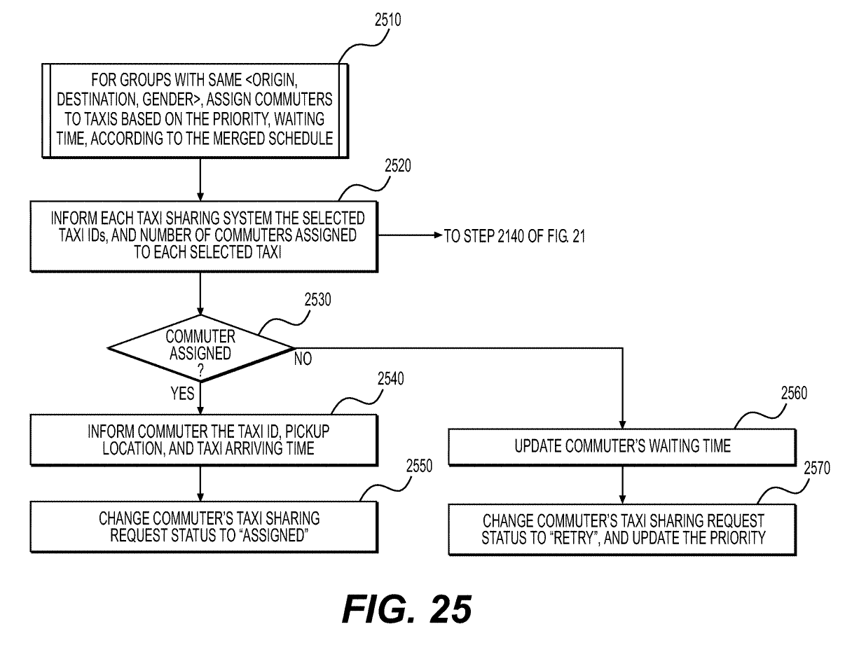

FIG. 25 is a flow diagram illustrating an example process for determining taxi assignments to commuters and informing the commuters of such information according to some implementations. The commuter assignment module 326 of the taxi sharing bridge system 110 may execute the process and algorithm structure of FIG. 25. The process is executed after the system merges the schedules from taxi sharing systems 120 in step 2320. In step 2510, the system assigns commuters in groups having the same origin 1910, destination 1920, and gender 1930 (of FIG. 19) to taxis in the merged schedule (FIG. 24) according to the priority 1940 of the group and the waiting time 1970 of the commuters within a group. For the groups having the same origin 1910, destination 1920, and gender 1930, the group of commuters are assigned in order of priority 1940. The commuters within the group are assigned in order of their waiting time 1970. In other words, of the groups of commuters having the same origin 1910, destination 1920, and gender 1930, the commuter group with the highest priority is assigned first and the commuter within the group that has the longest waiting time 1970 is assigned first.

The number of commuters in each group may change (in the sharing groups of FIG. 19), after the taxi sharing group request is sent (in step 1850). This is because taxi sharing initiation requests are sent to commuters for confirmation periodically (as in Steps 1320-Step 1360), and the process of the taxi sharing group request generation module 322 is also executed periodically (FIG. 18).

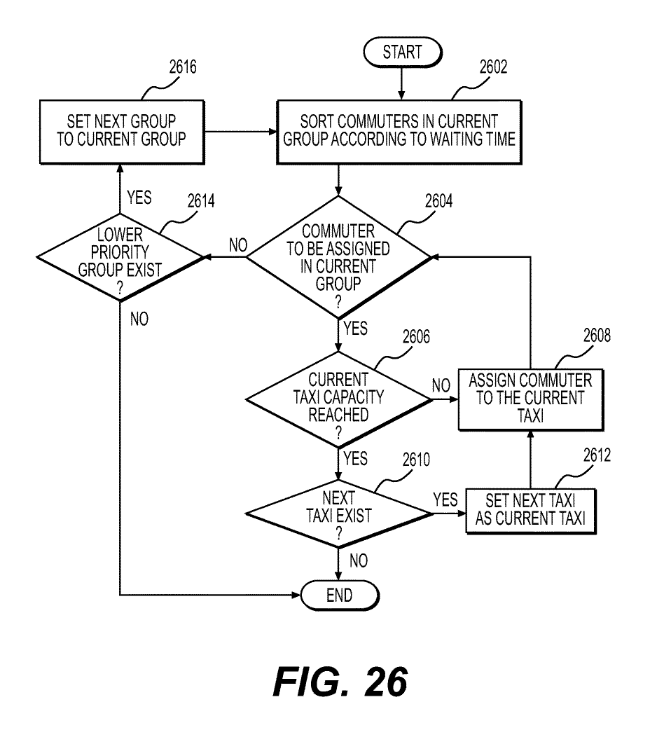

FIG. 26 illustrates an example of a flow diagram of a process for assigning commuters to taxis according to some implementations. The process of FIG. 26 is the detailed process of step 2510. The processes of FIG. 26 may be executed for each of the groups of commuter that have the same origin 1910, destination 1920, and gender 1930 (of the sharing groups in FIG. 19). Once the processing is ended for a collection of groups having the same origin 1910, destination 1920, and gender 1930, then another collection of groups having the same origin 1910, destination 1920, and gender 1930 is processed accordingly.

For a group, set as the current group, the commuters are sorted according to their waiting time 1970. Step 2604 determines whether there are commuters that still need to be assigned to a taxi but have not been assigned in the current group. If yes in step 2604, then step 2606 determines whether, in the current taxi, the capacity has been reached for that taxi. The current taxi is a taxi in the merged schedule selected for the group having the same group ID 2410 as the current group. The capacity for a taxi is determined based on the capacity 2440. If the capacity of the current taxi has not been reached (no in step 2606), then the system assigns the commuter to the current taxi in step 2608. Processing returns to step 2604 to determine whether another commuter exists in the current group.

If the capacity of the current taxi has been reached (yes in step 2606), then step 2610 determines whether there is another taxi in the merged schedule. The next taxi may come from the schedule for lower priority groups (in priority sequence), if they have same origin 1910, destination 1920, and gender 1930. If no in step 2610, then the processing ends for the current group. If yes, in step 2610, then the next taxi from the merged schedule is set as the current taxi in step 2612 and the commuter is assigned to this taxi.

In step 2604, if all commuters have been assigned in the current group (no in step 2604), then step 2614 determines whether there is a lower priority group. If there is not a lower priority group (no in step 2614), then the processing ends. If there is a lower priority group (yes in step 2614), then the lower priority group is set as the current group in step 2616 and processing continues to step 2602. The process repeats from 2604 to assign taxis for the commuters in the lower group.

Referring back to FIG. 25, in Step 2520, the system informs each taxi sharing system 120 the selected taxi ID 2430, which has commuters assigned to it, and the number of commuters assigned to each taxi. In Step 2530, the system determines if a commuter in the sharing groups (FIG. 19) has been assigned to a taxi. The system evaluates all commuters in all sharing groups. For each commuter, if the commuter is assigned (yes, in Step 2530), then in step 2540, the system informs the client device 130 of the commuter the assigned Taxi ID 2430, pickup location 2450, and taxi arriving time 2460. As mentioned above, the communication to the client device may be using an application on the client device 130 or via SMS, call, email, or other notification schemes.

In Step 2550, the system changes the commuter's status 1592 to “Assigned” in the taxi sharing request table 362. If the commuter is not assigned to a taxi (no in step 2530), in step 2560, the system updates the commuter's waiting time 1580 based on the current time. In step 2570, the system changes the commuter's status 1592 to “Retry”, and updates the priority 1590 according to the priority policy. As a result, the commuter's taxi sharing request will be included in the new sharing groups by taxi sharing group request generation module 322 (processing of FIG. 18).

Referring to FIG. 21, in Step 2140, the taxi sharing system waits for reply from the taxi sharing bridge system 110 for the assigned taxis. The taxi sharing system receives the taxi IDs and the number of commuters assigned to each selected taxi from the taxi sharing bridge system 110 (step 2520 of FIG. 25). In step 2150, the taxi sharing system 120 informs the selected taxis to start the sharing service, with the pickup location and number of commuters assigned for each selected taxis.

Various instructions, methods, and techniques described herein may be considered in the general context of computer-executable instructions, such as program modules stored on computer-readable media, and executed by the processor(s) herein. Generally, program modules include routines, programs, objects, components, data structures, etc., for performing particular tasks or implementing particular abstract data types. These program modules, and the like, may be executed as native code or may be downloaded and executed, such as in a virtual machine or other just-in-time compilation execution environment. Typically, the functionality of the program modules may be combined or distributed as desired in various implementations. An implementation of these modules and techniques may be stored on computer storage media or transmitted across some form of communication media.

While given components of the system have been described separately, one of ordinary skill will appreciate that some of the functions may be combined or shared in given instructions, program sequences, code portions, and the like.

What is claimed is:

1. A system able to group users of a transportation service into groups for sharing a taxi service upon a disruption in the transportation service, the system comprising:
a plurality of client devices associated with a plurality of users, each client device including a respective client device processor and a respective client device communication interface coupled to the respective client device processor for communicating over one or more networks;
a plurality of taxi sharing systems for arranging a taxi for one or more users, each taxi sharing system including a respective taxi sharing device processor and a respective taxi sharing device communication interface coupled to the respective taxi sharing device processor for communicating over the one or more networks;
a service computing device including a service computing device processor, and a service computing device communication interface coupled to the service computing device processor for communicating over the one or more networks with the plurality of client devices and the plurality of taxi sharing systems, the service computing device programmed to:
determine an origin, a destination, and a preferred route, of one or more routes from the origin to the destination, for each of the users using the transportation service based on data indicating prior use of the transportation system;
receive, from the transportation system, disruption information indicating a period of time the transportation system is disrupted and stations affected by the disruption;
determine users affected by the disruption based on the disruption information;
determine, a priority level indicating a relative priority compared to priority levels of other users, for each affected commuter;
group affected users into groups based on the origin, the destination, the gender, and the priority of each of the users;
assign users to the plurality of taxis, based on taxi schedule information received from each of the plurality of taxi sharing devices; and
send taxi assignment information to the plurality of client devices and the plurality of taxi sharing systems.

2. The system according to claim 1, wherein the service computing device is further programmed to:
determine the priority level for each user based on a waiting time of a the commuter at a particular location, the preferred route type of the user, and information indicating whether a loyalty of the user is high or low.

3. The system according to claim 2, wherein the service computing device is further programmed to:
dynamically determine the priority level for each user based on the waiting time of the user.

4. The system according to claim 1, wherein the service computing device is further programmed to:
assign users to the taxis based on the groups having the same origin, destination, gender, and priority,
wherein of groups having the same origin, destination, and gender, the users in a group of users having higher priorities are assigned before groups having lower priorities and within each priority group, a commuter having the longest waiting time is assigned before other commuters having a shorter waiting time.

5. The system according to claim 1, wherein the service computing device is further programmed to:
send information to each respective taxi sharing system indicating a number of users assigned to each individual taxi managed by the taxi sharing system, based on the assignment of the users to the plurality of taxis.

6. The system according to claim 1, wherein the service computing device is further programmed to:
determine if a user is not assigned to a taxi that is affected by the disruption and update the waiting time of the user if the user is not assigned.

7. The system according to claim 1, wherein the service computing device is further programmed to:
receive, from one or more of the plurality of taxi sharing systems, for each group, taxi schedule information including a taxi identification number identifying a taxi managed by the respective taxi sharing system that the taxi sharing system selected, a capacity of the selected taxi, the pickup location of the selected taxi and an estimated arriving time of the selected taxi; and
merge the taxi schedule information received from each taxi sharing system to generate a merged schedule indicating, for each group, the taxis managed by each taxi sharing system that are selected for the group, the taxi identification number for the selected taxi, the capacity of the selected taxi, the pickup location of the selected taxi, and the estimated taxi arriving time of the selected taxi.

8. The system according to claim 1, wherein the service computing device is further programmed to:
based on the data indicating prior use of the transportation system and the disruption information, determine a location where each user needs a taxi;
determine whether each user is within a predetermined time period from arriving to the location where the user needs a taxi based on the data indicating prior use of the transportation system; and
send, to each client device associated with a user, that is within the predetermined time period from arriving to the location, an initiation request.

9. A method to group users of a transportation system into groups for sharing a taxi service upon a disruption in the transportation service, the method comprising the steps of:
determining an origin, a destination, and a preferred route, of one or more routes from the origin to the destination, for each of the users using the transportation service based on data indicating prior use of the transportation system;
receiving, from the transportation system, disruption information indicating a period of time the transportation system is disrupted and stations affected by the disruption;
determining users affected by the disruption based on the disruption information;
determining a priority level indicating a relative priority compared to priority levels of other users, for each affected commuter;
grouping affected users into groups based on the origin, the destination, the gender, and the priority of each of the users;
assigning users to the plurality of taxis, based on taxi schedule information received from each of the plurality of taxi sharing devices; and
sending taxi assignment information to the plurality of client devices and the plurality of taxi sharing systems.

10. The method according to claim 9, further comprising the steps of:
determining the priority level for each user based on a waiting time of a the commuter at a particular location, the preferred route type of the user, and information indicating whether a loyalty of the user is high or low.

11. The method according to claim 10, further comprising the steps of:
dynamically determining the priority level for each user based on the waiting time of the user.

12. The method according to claim 9, further comprising the steps of:
assigning users to the taxis based on the groups having the same origin, destination, gender, and priority,
wherein of groups having the same origin, destination, and gender, the users in a group of users having higher priorities are assigned before groups having lower priorities and within each priority group, a commuter having the longest waiting time is assigned before other commuters having a shorter waiting time.

13. The method according to claim 9, further comprising the steps of:
sending information to each respective taxi sharing system indicating a number of users assigned to each individual taxi managed by the taxi sharing system, based on the assignment of the users to the plurality of taxis.

14. The method according to claim 9, further comprising the steps of:
determine if a user is not assigned to a taxi that is affected by the disruption and update the waiting time of the user if the user is not assigned.

15. The method according to claim 9, further comprising the steps of:
receiving, from one or more of the plurality of taxi sharing devices, for each group, taxi schedule information including a taxi identification number identifying a taxi managed by the respective taxi sharing system that the taxi sharing system selected, a capacity of the selected taxi, the pickup location of the selected taxi and an estimated arriving time of the selected taxi; and
merging the taxi schedule information received from each taxi sharing system to generate a merged schedule indicating, for each group, the taxis managed by each taxi sharing system that are selected for the group, the taxi identification number for the selected taxi, the capacity of the selected taxi, the pickup location of the selected taxi, and the estimated taxi arriving time of the selected taxi.

16. The method of claim 9, further comprising the steps of:
determining, based on the data indicating prior use of the transportation system and the disruption information, a location where each user needs a taxi;
determining whether each user is within a predetermined time period from arriving to the location where the user needs a taxi based on the data indicating prior use of the transportation system; and
sending, to each client device associated with a user, that is within the predetermined time period from arriving to the location, an initiation request.

17. One or more non-transitory computer readable media maintaining instructions that, when executed by one or more processors, cause the one or more processors to execute:
determining an origin, a destination, and a preferred route, of one or more routes from the origin to the destination for each of the users using the transportation service based on data indicating prior use of the transportation system;
receiving, from the transportation system, disruption information indicating a period of time the transportation system is disrupted and stations affected by the disruption;
determining users affected by the disruption based on the disruption information;
determining a priority level indicating a relative priority compared to priority levels of other users, for each affected commuter;
grouping affected users into groups based on the origin, the destination, the gender, and the priority of each of the users;
assigning users to the plurality of taxis, based on taxi schedule information received from each of the plurality of taxi sharing devices; and
sending taxi assignment information to the plurality of client devices and the plurality of taxi sharing systems.

18. The one or more non-transitory computer readable media according to claim 17, wherein the instructions further cause the one or more processors to execute:
determining the priority level for each user based on a waiting time of a the commuter at a particular location, the preferred route type of the user, and information indicating whether a loyalty of the user is high or low; and
dynamically determining the priority level for each user based on the waiting time.

19. The one or more non-transitory computer readable media according to claim 17, wherein the instructions further cause the one or more processors to execute:
assigning users to the taxis based on the groups having the same origin, destination, gender, and priority,
wherein of groups having the same origin, destination, and gender, the users in a group of users having higher priorities are assigned before groups having lower priorities and within each priority group, a commuter having the longest waiting time is assigned before other commuters having a shorter waiting time.

20. The one or more non-transitory computer readable media according to claim 17, wherein the instructions further cause the one or more processors to execute:
sending information to each respective taxi sharing device indicating a number of users assigned to each individual taxi managed by the taxi sharing system, based on the assignment of the users to the plurality of taxis.
